(19) United States
(12) Patent Application Publication
(10) Pub. No.: US 2026/0112222 A1
(43) Pub. Date: Apr. 23, 2026

(54) INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Kazuyuki SASAKI, Tokyo (JP)

(73) Assignee: NEC Corporation, Minato-ku, Tokyo (JP)

(21) Appl. No.: 19/118,878

(22) PCT Filed: Oct. 18, 2022
(86) PCT No.: PCT/JP2022/038815

§ 371 Date: Apr. 7, 2025

(51) Int. Cl. G07C 9/37; G06F 21/32

(52) U.S. Cl. CPC G07C 9/37; G06F 21/32

(57) ABSTRACT

An information processing apparatus includes: a setting unit that sets a first area including at least a part of a path with a flow of people heading toward a face authentication gate apparatus, based on gate information about a plurality of gate apparatuses including the face authentication gate apparatus; an image acquisition unit that acquires a first image including the first area; and a first determination unit that determines whether or not a first authentication subject, who is a person included in the acquired first image and located in the first area, is permitted to pass through the face authentication gate apparatus, based on a result of face authentication performed on the first authentication subject by using the acquired first image.

### TECHNICAL FIELD

The present disclosure relates to technical fields of an information processing apparatus, an information processing method, and a recording medium.

### BACKGROUND ART

For example, there is proposed a system in which a user located at a predetermined distance from a gate apparatus connected to a biometric authentication control unit, is detected as an authentication subject, in which biometric authentication and tracking of the authentication subject are started, and in which the authentication subject is permitted to pass through the gate apparatus in response to a success in the biometric authentication and tracking of the authentication subject at an entrance of the gate apparatus (see Patent Literature 1). Furthermore, prior art documents related to the present disclosure include Patent Literatures 2 to 5.

### CITATION LIST

### Patent Literature

Patent Literature 1: International Publication No. WO2022/149376
Patent Literature 2: International Publication No. WO 2022/003853
Patent Literature 3: Japanese Patent No. 7108243
Patent Literature 4: International Publication No. WO 2022/044086
Patent Literature 5: JP2011-204160A

### SUMMARY

### Technical Problem

It is an example object of the present disclosure to provide an information processing apparatus, an information processing method, and a recording medium that aim to improve the techniques/technologies disclosed in Citation List.

### Solution to Problem

An information processing apparatus according to an example aspect of the present disclosure includes: a setting unit that sets a first area including at least a part of a path with a flow of people heading toward a face authentication gate apparatus, based on gate information about a plurality of gate apparatuses including the face authentication gate apparatus; an image acquisition unit that acquires a first image including the first area; and a first determination unit that determines whether or not a first authentication subject, who is a person included in the acquired first image and located in the first area, is permitted to pass through the face authentication gate apparatus, based on a result of face authentication performed on the first authentication subject by using the acquired first image.

An information processing method according to an example aspect of the present disclosure includes: setting a first area including at least a part of a path with a flow of people heading toward a face authentication gate apparatus, based on gate information about a plurality of gate apparatuses including the face authentication gate apparatus; acquiring a first image including the first area; and determining whether or not a first authentication subject, who is a person included in the acquired first image and located in the first area, is permitted to pass through the face authentication gate apparatus, based on a result of face authentication performed on the first authentication subject by using the acquired first image.

A recording medium according to an example aspect of the present disclosure is a recording medium on which a computer program that allows a computer to execute an information processing method is recorded, the information processing method including: setting a first area including at least a part of a path with a flow of people heading toward a face authentication gate apparatus, based on gate information about a plurality of gate apparatuses including the face authentication gate apparatus; acquiring a first image including the first area; and determining whether or not a first authentication subject, who is a person included in the acquired first image and located in the first area, is permitted to pass through the face authentication gate apparatus, based on a result of face authentication performed on the first authentication subject by using the acquired first image.

An information processing apparatus according to another example aspect of the present disclosure includes: a path identification unit that identifies a path with a flow of people heading toward a face authentication gate apparatus; an image acquisition unit that acquires a third image including the identified path; a position detection unit that detects a position of a third authentication subject included in the third image, based on the acquired third image; a first determination unit that determines whether or not the third authentication subject is permitted to pass through the face authentication gate apparatus, based on a result of face authentication performed on the third authentication subject by using the acquired third image; and a second determination unit that determines whether or not to output third authentication subject information indicating the third authentication subject, on the basis of a moving direction of the third authentication subject based on a change in a position of the third authentication subject, and on the basis of the identified path, in response to a determination by the first determination unit that the third authentication subject is not permitted to pass through the face authentication gate apparatus.

### BRIEF DESCRIPTION OF DRAWINGS

FIG. 1 is a block diagram illustrating an example of a configuration of an information processing apparatus.

FIG. 2 is a block diagram illustrating an example of a configuration of an airport system.

FIG. 3 is a plan view illustrating an example of a floor on which a boarding gate is provided at an airport.

FIG. 4 is a plan view illustrating an example of a virtual authentication area.

FIG. 5 is a block diagram illustrating another example of the configuration of the information processing apparatus.

FIG. 6 is a diagram illustrating an example of a face database provided in the information processing apparatus.

FIG. 7 is a diagram for describing passenger tracking processing.

FIG. 8 is a diagram illustrating an example of an ID correspondence table.

FIG. 9 is a diagram illustrating an example of an image.

FIG. 10 is a flowchart illustrating a tracking and authentication operation according to a second example embodiment.

FIG. 11 is a diagram illustrating an example of a terminal apparatus.

FIG. 12 is a flowchart illustrating a determination operation according to the second example embodiment.

FIG. 13 is a block diagram illustrating an example of a configuration of an authentication apparatus.

FIG. 14 is a plan view illustrating another example of the virtual authentication area.

### DESCRIPTION OF EXAMPLE EMBODIMENTS

An information processing apparatus, an information processing method, and a recording medium according to example embodiments will be described.

### First Example Embodiment

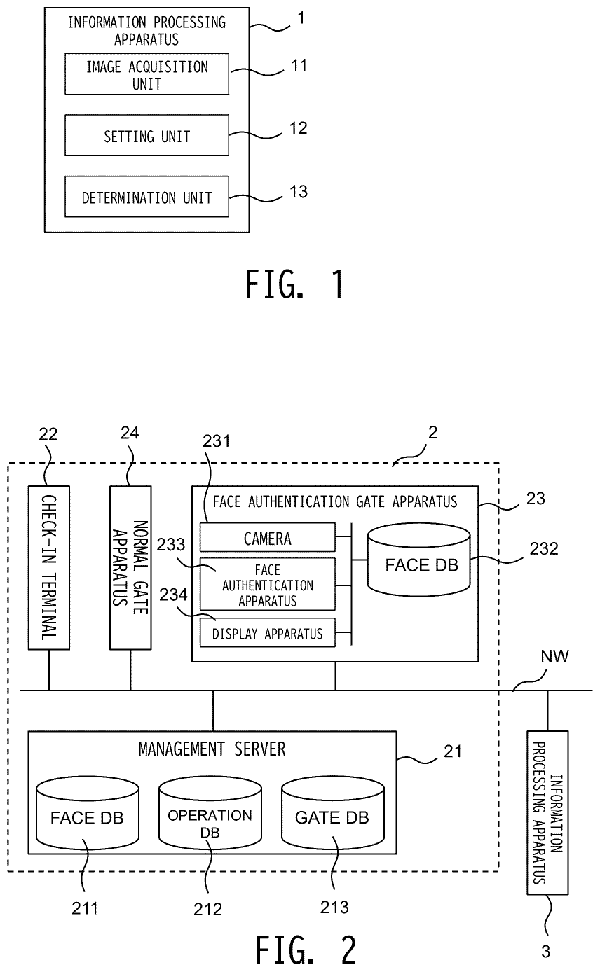

An information processing apparatus, an information processing method, and a recording medium according to a first example embodiment will be described with reference to FIG. 1. The following describes the information processing apparatus, the information processing method, and the recording medium according to the first example embodiment, by using an information processing apparatus 1. In FIG. 1, an information processing apparatus 1 includes an image acquisition unit 11, a setting unit 12, and a determination unit 13.

The setting unit 12 sets a first area including at least a part of a path with a flow of people heading toward a face authentication gate apparatus, based on gate information about a plurality of gate apparatuses including the face authentication gate apparatus. The plurality of gate apparatuses may be disposed at one location (e.g., at one entrance/exit), or may be disposed at a plurality of locations (e.g., at a plurality of entrances/exits). The gate information may include at least one of an operating status of each of the plurality of gate apparatuses, identification information on each of the plurality of gate apparatuses (i.e., information for identifying each gate apparatus), a position, and an apparatus type. The gate information may include at least one of the number of the face authentication gate apparatuses in operation, a position of the face authentication gate apparatus in operation, and identification information set for the face authentication gate apparatus.

The operating status of the gate apparatus may include an active state (e.g., a state in which processing for determining whether or not to permit a person to pass through can be performed) and an inactive state (e.g., a state in which processing for determining whether or not to permit a person to pass through cannot be performed). The inactive state may include a state in which no electric power is supplied to the gate apparatus (e.g., a power OFF state), and a state in which the gate apparatus is not allowed to perform its function even though electric power is supplied to a part of the gate apparatus (a so-called standby state). The face authentication gate apparatus may not be limited to a gate apparatus having only a function of determining whether or not to permit a person to pass through by face authentication processing, but may also include a gate apparatus in which the function of determining whether or not to permit a person to pass through by the face authentication processing is enabled/activated (i.e., a gate authentication functioning as the face authentication gate apparatus), out of gate apparatuses configured to switch between the function of determining whether or not to permit a person to pass through by the face authentication processing and a function of determining whether or not to permit a person to pass through by processing differing from the face authentication processing (e.g., by reading a two-dimensional bar code).

The setting unit 12 may set the first area, based on a map (e.g., a floor map) of a location where the plurality of gate apparatuses are disposed. Here, the first area is an area including at least a part of the path with a flow of people heading toward the face authentication gate apparatus. For example, the setting unit 12 may estimate the path with a flow of people heading toward the face authentication gate apparatus, based on the position of the face authentication gate apparatus on the map and a shape of the path leading to the face authentication gate apparatus. The setting unit 12 may set the first area, based on the estimated path. The map (e.g., the floor map) may include facility information. The facility information may include store information and equipment information (e.g., at least one of a toilet, a staircase, an escalator, and an elevator hall). The setting unit 12 may set the first area, based on the facility information included in the map. In this instance, the setting unit 12 may estimate the path with a flow of people heading toward the face authentication gate apparatus, based on the facility information.

The first area may be a virtually set area. In a case where the gate information indicates that the face authentication gate apparatus is not in operation (i.e., the face authentication gate apparatus is in the inactive state), the setting unit 12 does not need to set the first area. In other words, the setting unit 12 may set the first area only when the gate information indicates that the face authentication gate apparatus is in operation.

The face authentication gate apparatus permits a person having succeeded in face authentication to pass through, but does not permit a person having failed in the face authentication to pass through (e.g., in a case where the face authentication gate apparatus is a flap-type gate apparatus, a flap is in a closed state). The face authentication gate apparatus may determine that the face authentication is successful, when a face of a person attempting to pass through the face authentication gate apparatus corresponds to a face indicated by a pre-registered face image. In other words, the face authentication gate apparatus may determine that the face authentication is successful, when there is a person corresponding to the person attempting to pass through the face authentication gate apparatus, among those having pre-registered face images.

Therefore, in a case where the face image of the person attempting to pass through the face authentication gate apparatus is not registered, the face authentication gate apparatus does not permit the person to pass through. Therefore, when a person having no registered face image attempts to enter the face authentication gate apparatus, a flow of people passing through the face authentication gate apparatus is blocked due to the person not being permitted to pass through. That is, a throughput of the face authentication gate apparatus is reduced.

The image acquisition unit 11 acquires a first image that is an image including the first area. The first image may be an image included by a camera that is configured to include the first area. The first image is an image including the first area. Therefore, the first image may include a person heading toward the face authentication gate apparatus. A person included in the first image and located in the first area will be referred to as a first authentication subject. The determination unit 13 determines whether or not the first authentication subject is permitted to pass through the face authentication gate apparatus, based on a result of the face authentication performed on the first authentication subject by using the first image.

The determination result by the determination unit 13 may be outputted to a not-illustrated display apparatus. The display apparatus may be provided in the information processing apparatus 1, or may be an apparatus differing from the information processing apparatus 1. For example, with reference to the determination result by the determination unit 13, at least one of a guide and a security guard near the face authentication gate apparatus can judge the person not being permitted to pass through the face authentication gate apparatus. Then, at least one of the guide and the security guard is able to guide the person not being permitted to pass through the face authentication gate apparatus, so as not to enter the face authentication gate apparatus. Therefore, according to the information processing apparatus 1, it is possible to prevent the person not being permitted to pass through the face authentication gate apparatus from entering the face authentication gate apparatus. Therefore, according to the information processing apparatus 1, it is possible to prevent/control the reduction in the throughput of the face authentication gate apparatus.

In the information processing apparatus 1, first, the first area including at least a part of the path with a flow of people heading toward the face authentication gate apparatus may be set by the setting unit 12, based on the gate information about the plurality of gate apparatuses including the face authentication gate apparatus. Then, the first image, which is an image including the first area, may be acquired by the image acquisition unit 12. Then, it may be determined by the determination unit 13 whether or not the first authentication subject, who is a person included in the first image and located in the first area, is permitted to pass through the face authentication gate apparatus, based on the result of the face authentication performed on the first authentication subject by using the acquired first image.

Such an information processing apparatus 1 may be realized, for example, by a computer reading a computer program recorded on a recording medium. In this case, it can be said that a computer programs that allows a computer to execute an information processing method is recorded on a recording medium, the information processing method including: setting a first area including at least a part of a path with a flow of people heading toward a face authentication gate apparatus, based on gate information about a plurality of gate apparatuses including the face authentication gate apparatus; acquiring a first image including the first area; and determining whether or not a first authentication subject, who is a person included in the acquired first image and located in the first area, is permitted to pass through the face authentication gate apparatus, based on a result of face authentication performed on the first authentication subject by using the acquired first image.

### Second Example Embodiment

An information processing apparatus, an information processing method, and a recording medium according to a second example embodiment will be described with reference to FIG. 2 to FIG. 12. The following describes the information processing apparatus, the information processing method, and the recording medium according to the second example embodiment, by using an information processing apparatus 3 used at an airport.

First, an airport system 2 at the airport will be described with reference to FIG. 2. In FIG. 2, the airport system 2 includes a management server 21, a check-in terminal 22, and a plurality of gate apparatuses disposed at a boarding gate. The management server 21, the check-in terminal 22, and the plurality of gate apparatuses are connected to each other via a network NW.

The airport system 2 may include another check-in terminal, in addition to the check-in terminal 22. That is, the airport system 2 may include a plurality of check-in terminals. The network NW may be a wide area network (WAN) such as the Internet, or may be a local area network (LAN).

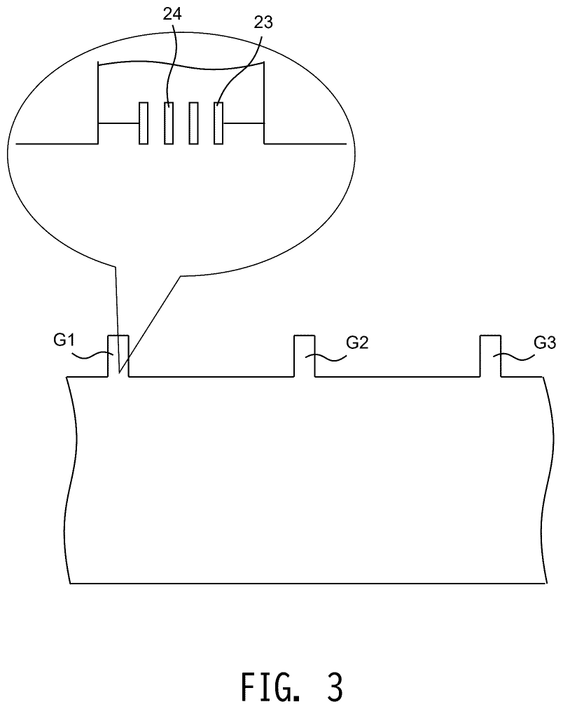

The plurality of gate apparatuses include a face authentication gate apparatus 23 that has a face authentication function of performing the face authentication processing and that determines whether or not to permit a passenger to pass through depending on a result of the face authentication processing, and a gate apparatus 24 that determines whether or not to permit a passenger to pass through based on an airline ticket/boarding pass carried by the passenger. The gate apparatus 24 is hereinafter referred to as a “normal gate apparatus 24” as appropriate. As illustrated in FIG. 3, let us assume that there are boarding gates G1, G2 and G3 at the airport. The face authentication gate apparatus 23 and the normal gate apparatus 24 are assumed to be disposed at the boarding gate G1.

The “airline ticket” may mean at least one of a paper airline ticket and an electronic airline ticket. The “airline ticket” may conceptually include, in addition to or in place of at least one of the paper airline ticket and the electronic airline ticket, those indicating personal information associated with the electronic airline ticket (e.g., a passport, a credit card used to purchase the airline ticket, etc.).

The management server 21 includes a face database 211 (hereinafter referred to as a “face DB 211”), an operation database 212 (hereinafter referred to as an “operation DB 212”), and a gate database 213 (hereinafter referred to as a “gate DB 213”).

In the face DB 211, a face image used for the face authentication processing is registered. In addition to or in place of the face image, a feature quantity about the face image may be registered in the face DB 211. In the operation DB 212, operation information (so-called flight information) about aircrafts is registered. The operation information may include a flight number of the aircraft, gate identification information for identifying the boarding gate (e.g., a boarding gate number), and a boarding starting time. The flight number of the aircraft, the identification information, and the boarding start time may be associated with one another.

In the gate DB 213, a plurality of pieces of boarding gate information respectively corresponding to a plurality of boarding gates are registered. It should be noted that a party performing at least one of management and operation of the airport system 2 may be different from an airport company(s) performing the management and operation of the airport and from an airline company(s) performing the operation of aircrafts. The plurality of pieces of boarding gate information registered in the gate DB 213 may be acquired from a system(s) associated with at least one of the airport company(s) and the airline company(s). The gate DB 213 may be shared by the airport system 2 and by the system(s) associated with at least one of the airport company(s) and the airline company(s).

The boarding gate information may include gate identification information for identifying the boarding gate (e.g., a boarding gate number), and apparatus information about the disposed gate apparatuses. The apparatus information may be information indicating at least one of the number of the gate apparatuses, and a type, an operating status, and a disposed position of each gate apparatus. Here, the type of the gate apparatus may include a first type in which the face authentication is possible, and a second type in which the face authentication is not possible. The gate apparatus of the second type may include a gate apparatus configured to read those (e.g., a two-dimensional bar code, etc.) indicating information for identifying a passenger (e.g., an ID).

The operating status of the gate apparatus may include an active state in which the gate apparatus is in operation and an inactive state in which the gate apparatus is paused (i.e., not in operation). The disposed position of the gate apparatus may be expressed as a relative positional relation of two or more gate apparatuses in a case where the two or more gate apparatuses are disposed at one boarding gate, for example. Alternatively, the disposed position of the gate apparatus may be expressed as coordinates of each gate apparatuses in a coordinate system of a floor on which the boarding gate is provided at the airport (a so-called departure floor), for example. In a case where only one gate apparatus is disposed at one boarding gate, the apparatus information may not include the disposed position of the gate apparatus. The plurality of pieces of boarding gate information registered in the gate DB 213 may be determined in advance depending on at least one of flights of aircraft and airline companies. The plurality of pieces of boarding gate information registered in the gate DB 213 may be automatically updated in response to departure times of aircrafts or the like. The boarding gate information corresponds to an example of the “gate information” in the first example embodiment.

The check-in terminal 22 is a terminal used for a boarding procedure (i.e., check-in). The check-in terminal 22 may be operated by an airport staff or by a passenger (i.e., the check-in terminal 22 may be a so-called self-service check-in machine). The “airport staff” is not limited to those belonging to the airport company(s) that manages and operates the airport, but conceptually includes those working at the airport, such as those belonging to the airline company(s) that operates aircrafts.

The check-in terminal 22 performs the boarding procedure of a passenger, based on the airline ticket carried by the passenger. The check-in terminal 22 may acquire the face image of the passenger during the boarding procedure. The check-in terminal 22 may acquire the face image of the passenger by capturing an image of the passenger with a camera, or may acquire the face image of the passenger by reading a photograph of the face printed in a passport carried by the passenger. The check-in terminal 22 may not acquire the face images of all the passengers.

The check-in terminal 22 transmits, to the management server 21, passenger information about a passenger performing the boarding procedure (e.g., the passenger's name and the flight number of the aircraft) and the face image of the passenger. The check-in terminal 22 may acquire the passenger information from information described in the airline ticket (in other words, information associated with the airline ticket).

The management server 21 associates the passenger information and the face image transmitted from the check-in terminal 22, with each other, and registers them in the face DB 211. At this time, the management server 21 may add passenger identification information for identifying the passenger, to the passenger information and the face image. As described later, the face image is used for the face authentication processing. Therefore, the passenger identification information added to the passenger information and the face image will be hereafter referred to as an “authentication ID” as appropriate. The face image of the passenger may be acquired by an application (e.g., an application provided by an airline company) installed in a terminal apparatus (e.g., a smartphone) carried by the passenger, or may be acquired by a gate apparatus disposed in an immigration area of the airport, in addition to or in place of the check-in terminal 22.

The management server 21 may identify the flight number of the aircraft, a first predetermined time (e.g., several minutes to tens of minutes) before the boarding start time, from the operation information registered in the operation DB 212, based on a current time. The management server 21 may extract the boarding gate information corresponding to the gate identification information, from the plurality of pieces of boarding gate information registered in the gate DB 213, based on the gate identification information associated with the identified flight number. The management server 21 may determine whether or not the face authentication gate apparatus (e.g., the face authentication gate apparatus 23) is disposed at the boarding gate corresponding to the extracted boarding gate information, based on the extracted boarding gate information.

When it is determined that the face authentication gate apparatus (e.g., the face authentication gate apparatus 23) is disposed, the management server 21 may extract, from the face DB 211, the face image of the passenger associated with the passenger information including the identified flight number (in other words, scheduled to board the aircraft with the identified flight number). The management server 21 may transmit the extracted face image to the face authentication gate apparatus (e.g., the face authentication gate apparatus 23) identified by the extracted boarding gate information. When it is determined that the face authentication gate apparatus is not disposed, the management server 21 may not perform the processing. When it is determined that the face authentication gate apparatus is disposed, the management server 21 may determine whether or not the disposed face authentication gate apparatus is in operation, based on the extracted boarding gate information. In a case where the feature quantity about the face image is registered in the face DB 211, the management server 21 may transmit the feature quantity about the face image to the face authentication gate apparatus, in addition to or in place of the face image.

The face authentication gate apparatus 23 includes a camera 231, a face database 232 (hereinafter referred to as a “face DB 232”), and a face authentication apparatus 233. The face image transmitted from the management server 21 is registered in the face DB 232. The face authentication gate apparatus 23 may include a display apparatus 234. The display apparatus 234 may display thereon at least one of an image included by the camera 231 and information indicating a result of the face authentication processing.

The face authentication apparatus 233 performs the face authentication processing, by using the image included by the camera 231 (e.g., the image in which a face of the passenger is included) and the face image registered in the face DB 232. In a case where the face authentication is successful, the face authentication gate apparatus 23 permits the passenger to pass through. On the other hand, in a case where the face authentication is failed, the face authentication gate apparatus 23 does not permit the passenger to pass through. Various existing aspects (e.g., at least one of a two-dimensional (2D) authentication method and a three-dimensional (3D) authentication method) are applicable to the face authentication processing.

A specific example of the face authentication processing in the face authentication gate apparatus 23 will be described. The face authentication gate apparatus 23 may be a flap-type gate apparatus. The face authentication apparatus 233 may extract the feature quantity of the image included by the camera 231. The face authentication apparatus 233 may collate/verify the extracted feature quantity with the feature quantity relating to the face image registered in the face DB 232. At this time, the face authentication apparatus 233 may calculate a matching score (or a similar score), based on the extracted feature quantity and the feature quantity relating to the face image registered in the face DB 232. When the matching score is greater than or equal to a threshold (i.e., when the face authentication is successful), the face authentication apparatus 233 may permit the passenger to pass through. At this time, the face authentication apparatus 233 may identify the authentication ID relating to the passenger. In this case, the face authentication gate apparatus 23 may open a flap. When the matching score is less than the threshold (i.e., when the face authentication is failed), the face authentication apparatus 233 may not permit the passenger to pass through. In this case, the face authentication gate apparatus 23 may close the flap. In addition to or in place of the face image, the feature quantity relating to the face image may be registered in the face DB 232. Another apparatus (e.g., the management server 21) that differs from the face authentication gate apparatus 23 may perform a part of the face authentication processing. In this case, the face authentication apparatus 233 of the face authentication gate apparatus 23 may extract the feature quantity of the image included by the camera 231. The face authentication apparatus 233 may transmit the extracted feature quantity to the other apparatus. The other apparatus may collate/verify the feature quantity transmitted from the face authentication apparatus 233 with the feature quantity relating to the face image registered in a face database (e.g., the face DB 211). The other apparatus may transmit information indicating a verification result (e.g., information indicating whether or not the matching score is greater than or equal to the threshold) to the face authentication gate apparatus 23. When the matching score is greater than or equal to the threshold, the other apparatus may include the authentication ID relating to the passenger, in the information indicating the verification result. In a case where the information indicating the verification result indicates that matching score is greater than or equal to the threshold, the face authentication apparatus 233 may permit the passenger to pass through. In a case where the information indicating the verification result indicates that matching score is less than the threshold, the face authentication apparatus 233 may not permit the passenger to pass through.

In the face authentication gate apparatus 23, a passing speed of the passenger is expectedly faster than that in the normal gate apparatus 24. In other words, the number of passengers passing through the face authentication gate apparatus 23 in a predetermined time period is expectedly greater than the number of passengers passing through the normal gate apparatus 24. That is, the face authentication gate apparatus 23 is capable of improving the throughput at the boarding gate.

As described above, however, a passenger being permitted to pass through the face authentication gate apparatus 23 is only a passenger having succeeded in the face authentication. In order for a passenger to succeed in the face authentication in the face authentication gate apparatus 23, the face image of the passenger needs to be registered in the face DB 232 of the face authentication gate apparatus 23. If a passenger having no face image registered in the face DB 232 enters the face authentication gate apparatus 23, the throughput at the boarding gate is reduced due to the passenger not being permitted to pass through.

In view of the above-described problems, the information processing apparatus 3 determines whether or not a passenger is permitted to pass through the face authentication gate apparatus 23 before the passenger enters the face authentication gate 23. That is, the information processing apparatus 3 determines whether or not a passenger is permitted to pass through the face authentication gate apparatus 23, separately from the face authentication gate apparatus 23.

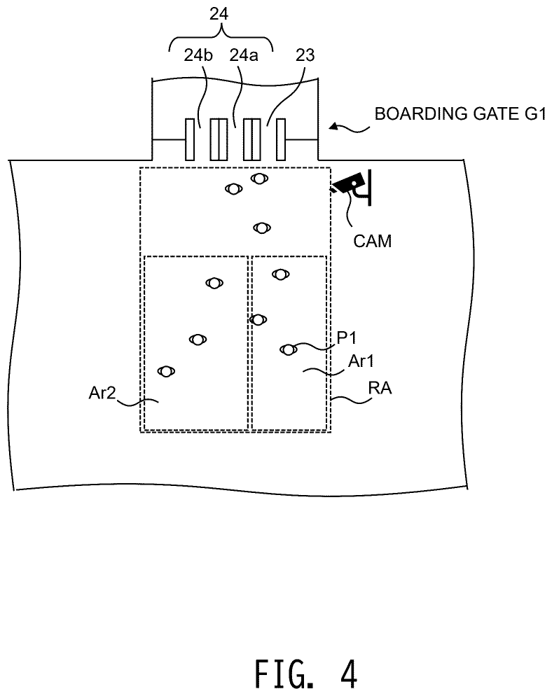

As illustrated in FIG. 4, a virtual authentication area RA is provided around the boarding gate G1 in which the face authentication gate apparatus 23 and the normal gate apparatus 24 are disposed. The authentication area RA is an area in which a plurality of passengers pass toward one of the face authentication gate apparatus 23 and the normal gate apparatus 24 pass.

A camera CAM is disposed so as to image/include the authentication area RA. The camera CAM may be connected to the information processing apparatus 3 via the network NW. The camera CAM may not be disposed to include all of the authentication area RA in its angle of view. In other words, the camera CAM may be disposed to image/include at least a part of the authentication area RA. The camera CAM may be disposed at a position that does not interfere with the passage of passengers (e.g., at a position that is higher than the passengers' heads). As described later, an image included by the camera CAM may be used for the face authentication processing. Therefore, the camera CAM may be a high-resolution camera, such as a 4K resolution camera. The camera CAM may not be connected to the information processing apparatus 3 via the network NW. In this instance, the camera CAM may be connected to the information processing apparatus 3 via a cable (e.g., a USB (Universal Serial Bus) cable).

The camera CAM may generate a first image that is an image including the authentication area RA, by imaging the authentication area RA. The first image may be an image corresponding to one frame of a video.

The information processing apparatus 3 performs the face authentication processing by using the first image generated by the camera CAM imaging the authentication area RA, and determines, before a passenger included in the first image enters the face authentication gate apparatus 23, whether or not the passenger is permitted to pass through the face authentication gate apparatus 23. Hereinafter, the information processing apparatus 3 will be described in detail.

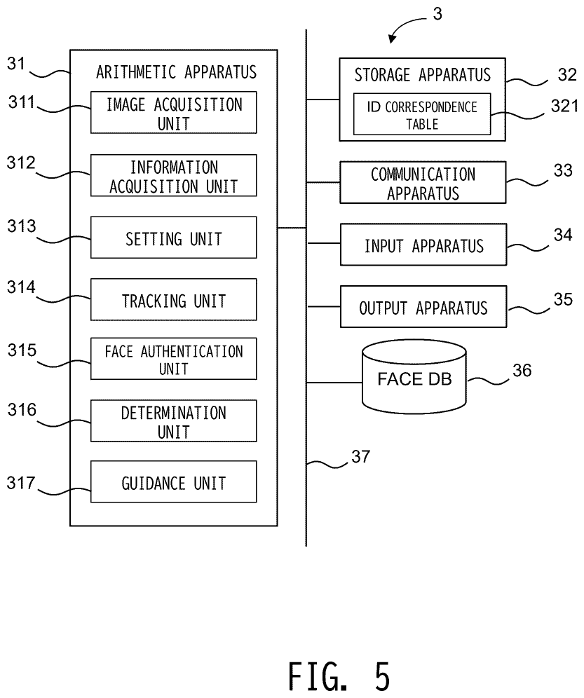

As illustrated in FIG. 5, the information processing apparatus 3 includes an arithmetic apparatus 31, a storage apparatus 32, and a communication apparatus 33. The information processing apparatus 3 may include an input apparatus 34 and an output apparatus 35. The information processing apparatus 3 may include a face database 36 (hereinafter referred to as a “face DB36”). The information processing apparatus 3 may not include at least one of the input apparatus 34 and the output apparatus 35. In the information processing apparatus 3, the arithmetic apparatus 31, the storage apparatus 32, the communication apparatus 33, the input apparatus 34, the output apparatus 35, and the face DB36 may be connected via a data bus 37. The information processing apparatus 3 is connected to the management server 21 via the communication apparatus 33 and the network NW. The information processing apparatus 3 may constitute a part of the airport system 2. In other words, the airport system 2 may include the information processing apparatus 3.

The arithmetic apparatus 31 may include, for example, at least one of a CPU (Central Processing Unit), a GPU (Graphics Processing Unit), a FPGA (Field Programmable Gate Array), a TPU (Tensor Processing Unit), and a quantum processor.

The storage apparatus 32 may include, for example, at least one of a RAM (Random Access Memory), a ROM (Read Only Memory, a hard disk apparatus, a magneto-optical disk apparatus, and a SSD (Solid State Drive), and an optical disk array. That is, the storage apparatus 32 may include a non-transitory recording medium. The storage apparatus 32 is configured to store desired data. For example, the storage apparatus 32 may temporarily store a computer program to be executed by the arithmetic apparatus 31. The storage apparatus 32 may temporarily store data that are temporarily used by the arithmetic apparatus 31 when the arithmetic apparatus 31 executes the computer program.

The communication apparatus 33 is configured to communicate with the management server 21 via the network NW. The communication apparatus 33 may communicate with an apparatus external to the information processing apparatus 3, other than the management server 21, via the network NW. The communication apparatus 33 may perform wired communication or may perform wireless communication.

The input apparatus 34 is an apparatus that is configured to receive an input of information to the information processing apparatus 3 from the outside. It may include an operating apparatus (e.g., a keyboard, a mouse, a touch panel, etc.) that is operable by an operator of the information processing apparatus 3. The input apparatus 34 may include a recording medium reading apparatus that is configured to read information recorded on a recording medium that is detachable from the information processing apparatus 3, such as, for example, a USB memory. When information is inputted to the information processing apparatus 3 via the communication apparatus 33 (in other words, when the information processing apparatus 3 acquires information via the communication apparatus 33), the communication apparatus 33 may function as an input apparatus.

The output apparatus 35 is an apparatus that is configured to output information to the outside of the information processing apparatus 3. The output apparatus 35 may output, as the above information, visual information such as characters and images, may output auditory information such as sound/audio, or may output tactile information such as vibrations. The output apparatus 35 may include, for example, at least one of a display, a speaker, a printer, and a vibrating motor. The output apparatus 35 may be configured to output information to a recording medium that is detachable from the information processing apparatus 3, such as, for example, a USB memory. When the information processing apparatus 3 outputs the information via the communication apparatus 33, the communication apparatus 33 may function as an output apparatus.

The arithmetic apparatus 31 may include an image acquisition unit 311, an information acquisition unit 312, a setting unit 313, a tracking unit 314, a face authentication unit 315, a determination unit 316, and a guidance unit 317, as logically realized functional blocks, or physically realize processing circuits. At least one of the image acquisition unit 311, the information acquisition unit 312, the setting unit 313, the tracking unit 314, the face authentication unit 315, the determination unit 316, and the guidance unit 317 may be realized in a form in which a logical functional block and a physical processing circuit (i.e., hardware) are mixed. In a case where at least a part of the image acquisition unit 311, the information acquisition unit 312, the setting unit 313, the tracking unit 314, the face authentication unit 315, the determination unit 316, and the guidance unit 317 is a functional block, at least a part of the image acquisition unit 311, the information acquisition unit 312, the setting unit 313, the tracking unit 314, the face authentication unit 315, the determination unit 316, and the guidance unit 317 may be realized by the arithmetic apparatus 31 executing a predetermined computer program.

The arithmetic apparatus 31 may acquire (in other words, may read) the predetermined computer program from the storage apparatus 32. The arithmetic apparatus 31 may read the predetermined computer program stored by a computer-readable, non-transitory recording medium, by using a not-illustrated recording medium reading apparatus provided in the information processing apparatus 3. The arithmetic apparatus 31 may acquire (in other words, may downloaded or read) the predetermined computer program from a not-illustrated apparatus external to the information processing apparatus 3, via the communication apparatus 33. At least one of an optical disk, a magnetic medium, a magneto-optical disk, a semi-conductor memory, and any other medium configured to store a program, may be used as the recording medium that records therein the predetermined computer program to be executed by the arithmetic apparatus 31.

The management server 21 transmits at least a part of the face image registered in the face DB 211 to the information processing apparatus 3, together with the authentication ID (i.e., the passenger identification information) added to the face image. In this instance, in addition to the face image, the management server 21 may transmit the gate identification information and the boarding start time to the information processing apparatus 3. The management server 21 may identify the gate identification information and the boarding start time, based on the flight number of the aircraft included in the passenger information associated with the face image registered in the face DB 211 and based on the operation information registered in the operation DB 212. That is, the management server 21 may identify the gate identification information and the boarding start time, relating to the aircraft that the passenger indicated by the face image goes aboard. In a case where the feature quantity relating to the face image is registered in the face DB 211 in place of or in addition to the face image, the management server 21 may transmit the feature quantity relating to the face image to the information processing apparatus 3 in place of or in addition to the face image.

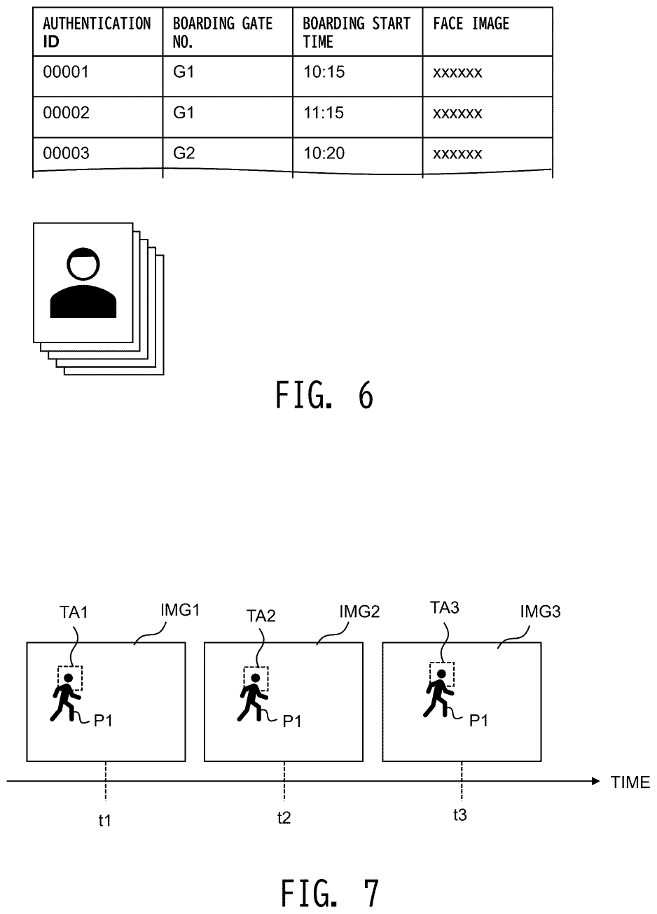

The information processing apparatus 3 registers, in the face DB36, the face image transmitted from the management server 21. In addition to the face image, the information processing apparatus 3 may register, in the face DB36, the gate identification information and the boarding start time. As illustrated in FIG. 6, the face DB36 may include (i) a plurality of face images, and (ii) a table that associates the authentication ID, the gate identification information (e.g., a boarding gate number), the boarding start time, and the face image with one another. The management server 21 may transmit at least a part of the face image registered in the face DB 211 to the information processing apparatus 3 in a predetermined cycle. The information processing apparatus 3 may update the face image registered in the face DB36 at each time when the face image is transmitted from the management server 21. In a case where the management server 21 transmits the feature quantity relating to the face image to the information processing apparatus 3 in place of or in addition to the face image, the feature quantity relating to the face image may be registered in the face DB36 in place of or in addition to the face image.

The image acquisition unit 311 of the arithmetic apparatus 31 may acquire one or more first images generated by the camera CAM via the communication apparatus 33. The image acquisition unit 311 may store the acquired one or more first images in the storage apparatus 32. The information acquisition unit 312 of the arithmetic apparatus 31 acquires the boarding gate information about the boarding gate G1 from the gate DB 213 of the management server 21, via the communication apparatus 33. The information acquisition unit 312 may store the acquired boarding gate information in the storage apparatus 32.

The setting unit 313 of the arithmetic apparatus 31 may identify gate apparatuses disposed at the boarding gate G1, based on the apparatus information included in the boarding gate information about the boarding gate G1. Here, the boarding gate G1 is assumed to be provided with the face authentication gate apparatus 23 and normal gate apparatuses 24a and 24b serving as the normal gate apparatus 24 (see FIG. 4).

The setting unit 313 may identify a gate apparatus in operation, from the identified gate apparatuses, based on the apparatus information. The setting unit 313 may identify a position of the gate apparatus in operation, based on the apparatus information. Here, the face authentication gate apparatus 23 and the normal gate apparatuses 24a and 24b are assumed to be in operation.

The setting unit 313 may set a virtual area Ar1 including at least a part of a path with a flow of people heading toward the face authentication gate apparatus 23, based on a position of the face authentication gate apparatus 23 (see FIG. 4). The setting unit 313 may set a virtual area Ar2 including at least a part of a path with a flow of people heading toward the normal gate apparatuses 24a and 24b, based on the positions of the normal gate apparatuses 24a and 24b (see FIG. 4). In FIG. 4, the areas Ar1 and Ar2 are set as areas in the authentication area RA. At least a part of the area Ar1, however, may be out of the authentication area RA. Similarly, at least a part of the area Ar2 may be out of the authentication area RA.

When the face authentication gate apparatus 23 is not in operation (i.e., the face authentication gate apparatus 23 is in the inactive state), the setting unit 313 may not set the area Ar1. When the normal gate apparatuses 24a and 24b are not in operation (i.e., when the normal gate apparatuses 24a and 24b are in the inactive state), the setting unit 313 may not set the area Ar2. When one of the normal gate apparatuses 24a and 24b is in operation and the other of the normal gate apparatuses 24a and 24b is not in operation, the setting unit 313 may change at least one of a position and size of the area Ar2, based on a position of one of the normal gate apparatuses 24a and 24b.

That is, the setting unit 313 may determine whether or not to set the area (e.g., at least one of the areas Ar1 and Ar2), based on the operating status of each of the plurality of gate apparatuses including the face authentication gate apparatus 23 and the normal gate apparatuses 24a and 24b, and may determine at least one of a position and size of the set area. The setting unit 313 may associate the set area with apparatus identification information for identifying the gate apparatus. The setting unit 313 may associate the area Ar1 with apparatus identification information about the face authentication gate apparatus 23. The setting unit 313 may associate the area Ar2 with apparatus identification information about each of the normal gate apparatuses 24a and 24b.

The operating status of each of the plurality of gate apparatuses may be changed in response to the operation information about aircrafts. The operating status of the gate apparatus may be changed from the active state to the inactive state in a case where the current time has passed the departure time of a certain aircraft. The operating status of the gate apparatus may be changed from the active state to the inactive state in a case where the current time is a second predetermined time (e.g., 30 minutes) before the boarding start time of a certain aircraft. The setting unit 313 may acquire the boarding gate information from the gate DB 213 of the management server 21, based on the operation information about aircrafts. For example, in a case where the current time has passed the departure time of a certain aircraft, the setting unit 313 may acquire the boarding gate information from the gate DB 213. The setting unit 313 may then cancel the setting of the area (e.g., at least one of the areas Ar1 and Ar2) that is set when the gate apparatus is in the active state, wherein the operating status is changed from the active state to the inactive state in the gate apparatus. For example, in a case where the current time is the second predetermined time before the boarding start time of a certain aircraft, the setting unit 313 may acquire the boarding gate information from the gate DB 213. The setting unit 313 may then set a new area (e.g., at least one of the areas Ar1 and Ar2) in response to the position of the gate apparatus, wherein the operating status is changed from the inactive state to the active state in the gate apparatus.

The operating status of the gate apparatus may be determined in advance for each flight of aircrafts. That is, the operating status of each of the plurality of gate apparatuses when boarding one aircraft and the operating status of each of the gate apparatuses when boarding another aircraft, may be determined in advance. For example, in a case where the current time has passed the departure time of one aircraft or in a case where the current time is the second predetermined time before the boarding start time of another aircraft, the setting unit 313 may acquire, from the gate DB 213, the boarding gate information when boarding to another aircraft. In this case, the setting unit 313 may change the area (e.g., at least one of the areas Ar1 and Ar2) that is set when boarding one aircraft, based on the acquired boarding gate information (specifically, the operating status of the gate apparatus).

For example, the setting unit 313 may change the size of the area Ar1 in response to the number of the face authentication gate apparatuses 23 disposed at the boarding gate G1. For example, the setting unit 313 may change the position of the area Ar1, in response to the position of the face authentication gate apparatus 23 at the boarding gate G1. For example, the setting unit 313 may determine a longitudinal width of the area Ar1 (e.g., a width in a direction along a traveling direction when the passenger passes through the face authentication gate apparatus 23) in response to the number of the face authentication gate apparatuses 23 disposed at the boarding gate G1, and may determine a lateral width of the area Ar1 (e.g., a width in a direction intersecting the traveling direction when the passenger passes through the face authentication gate apparatus 23) in response to the position of the face authentication gate apparatus 23. In this instance, the setting unit 313 may determine at least one of a maximum value and a minimum value of each of the longitudinal width and the lateral width of the area Ar1, based on the floor map of the airport. For example, the setting unit 313 may determine a shape of the area Ar1 (e.g., square, rectangular, L-shaped, etc.), based on the floor map of the airport.

For example, the setting unit 313 may change the size of the area Ar2 in response to the number of the normal gate apparatuses 24 disposed at the boarding gate G1. For example, the setting unit 313 may change the position of the area Ar2 in response to the position of the normal gate apparatus 24 at the boarding gate G1. For example, the setting unit 313 may determine a longitudinal width of the area Ar2 (e.g., a width in a direction along a traveling direction when the passenger passes through the normal gate apparatus 24) in response to the number of the normal gate apparatuses 24 disposed at the boarding gate G1, and may determine a lateral width of the area Ar2 (e.g., a width in a direction intersecting the traveling direction when the passenger passes through the normal gate apparatus 24) in response to the position of the normal gate apparatus 24. In this instance, the setting unit 313 may determine at least one of a maximum value and a minimum value of each of the longitudinal width and the lateral width of the area Ar2, based on the floor map of the airport. For example, the setting unit 313 may determine a shape of the area Ar2 (e.g., square, rectangular, L-shaped, etc.), based on the floor map of the airport.

The floor map of the airport may include facility information. The facility information may include store information and equipment information (e.g., at least one of a toilet, a staircase, an escalator, and an elevator hall).

Operation patterns of the plurality of gate apparatuses at a certain boarding gate (e.g., the boarding gate G1) may be associated in advance with the position and size of the area (e.g., at least one of the areas Ar1 and Ar2). In this instance, the setting unit 313 may identify the above-described operation pattern, based on the boarding gate information acquired from the gate DB 213. The setting unit 313 may then set the area, based on the position and size of the area associated with the identified operation pattern.

The tracking unit 314 of the arithmetic apparatus 31 tracks one or more passengers passing through the authentication area RA, by using a plurality of first images acquired by the image acquisition unit 311 (i.e., a plurality of first images generated by the camera CAM). The face authentication unit 315 of the arithmetic apparatus 31 performs the face authentication processing on one or passengers passing through the authentication area RA, by using a plurality of first images acquired by the image acquisition unit 311.

With reference to FIG. 7, a case where the tracking unit 314 performs tracking processing of a passenger P1 passing through the authentication area RA illustrated in FIG. 4 and the face authentication unit 315 performs the face authentication processing on the passenger P1, will be described. Since the passenger P1 is also a target person of the face authentication processing, it may be referred to as an authentication subject.

Images IMG1, IMG2 and IMG3 illustrated in FIG. 7 are images including the passenger P1 (in other words, images in which the passenger P1 is included). The image IMG1 is an image generated by the camera CAM imaging the authentication area RA at a time t1. The image IMG2 is an image generated by the camera CAM imaging the authentication area RA at a time t2 that is after the time t1. The image IMG3 is an image generated by the camera CAM imaging the authentication area RA at a time t3 that is after the time t2.

Each of the images IMG1, IMG2 and IMG3 may be an image corresponding to one frame of a video. In such a case, the image IMG2 may not be an image corresponding to a frame immediately after a frame corresponding to the image IMG1. That is, the image IMG2 may be an image corresponding to a frame existing two or more frames after the frame corresponding to the image IMG1. Similarly, the image IMG3 may not be an image corresponding to a frame immediately after a frame corresponding to the image IMG2. That is, the image IMG3 may be an image corresponding to a frame existing two or more frames after the frame corresponding to the image IMG2.

The tracking unit 314 detects, from the image IMG1, a head of the passenger P1 included in the image IMG1. Since an existing technique/technology is applicable to a method of detecting the human head from the image, a detailed description of the method will be omitted. The tracking unit 314 sets an area including the head of the passenger P1 as a tracking area TA1, based on the detected head of the passenger P1.

When setting the tracking area TA1, the tracking unit 314 sets, for the passenger P1, a tracking ID that is identification information for identifying the passenger P1 relating to the tracking area TA. The tracking unit 314 calculates a position of the passenger P1, based on the tracking area TA1. Since an existing techniques/technologies are applicable to a method of calculating, from the image, the position of a subject included in the image, a detailed description of the method will be omitted. The tracking unit 314 may associate the tracking ID and the position of the passenger P1 with each other, and may register them in an ID correspondence table 321 stored in the storage apparatus 32.

When setting the tracking area TA1, the tracking unit 314 may determine whether or not the face of the passenger P1 is included in the tracking area TA1. In other words, the tracking unit 314 may perform face detection for the tracking area TA1. When it is determined that the face of the passenger P1 is included in the tracking area TA1, the tracking unit 314 generates a face image including a face area of the passenger P1. The tracking unit 314 transmits, to the face authentication unit 315, the generated face image in association with the tracking ID relating to the passenger P1. When it is determined that the face of the passenger P1 is not included in the tracking area TA1, the tracking unit 314 may not generate the face image.

The face authentication unit 315 performs the face authentication processing, by using the face image transmitted from the tracking unit 314 and the face image registered in the face DB36.

The face authentication unit 315 may extract the feature quantity of the face image transmitted from the tracking unit 314. The face authentication unit 315 may collate/verify the feature quantity of the face image transmitted from the tracking unit 314 with the feature quantity relating to the face image registered in the face DB36. At this time, the face authentication unit 315 may calculate a matching score (or a similarity score), based on the extracted feature quantity and the feature quantity relating to the face image registered in the face DB36. The face authentication unit 315 may compare the matching score with a threshold. When the matching score is greater than or equal to the threshold, the face authentication unit 315 may determine that the face indicated by the face image transmitted from the tracking unit 314 corresponds to the face indicated by one of the face images registered in the face DB36. When the matching score is less than the threshold, the face authentication unit 315 may determine that the face image indicating the face corresponding to the face indicated by the face image transmitted from the tracking unit 314 is not registered in the face DB36.

When the face indicated by the face image transmitted from the tracking unit 314 corresponds to the face indicated by one of the face images registered in the face DB36 (in other words, when the face authentication is successful), the face authentication unit 315 associates the authentication ID corresponding to one face image, with the tracking ID corresponding to the face image transmitted from the tracking unit 314, and registers it in the ID correspondence table 321. The face authentication unit 315 may register, in the ID correspondence table 321, an authentication time that is a time at which the face authentication processing is performed, in addition to the authentication ID.

When the face image indicating the face corresponding to the face indicated by the face image transmitted from the tracking unit 314 is not registered in the face DB36 (in other words, when the face authentication is failed), the face authentication unit 315 may associate information indicating that there is no applicable person (e.g., “N/A (Not Applicable)”), with the tracking ID corresponding to the face image transmitted from the tracking unit 314, and may register it in the ID correspondence table 321.

The tracking unit 314 may identify the passenger P1 included in the image IMG2, by using the image IMG2 and the image IMG1. Identifying the passenger P1 included in the image IMG2 is synonymous with associating the passenger P1 included in the image IMG1 with the passenger P1 included in the image IMG2. Therefore, at least one of a matching method and an optical flow method relating to the association between the images, is applicable to the identification of the passenger P1 included in the image IMG2. Since various existing aspects are applicable to each of the matching method and the optical flow method, a detailed description of the methods will be omitted.

When the passenger P1 included in the image IMG2 is identified, the tracking unit 314 detects the head of the passenger P1. The tracking unit 314 sets the area including the head of the passenger P1, as a tracking area TA2, based on the detected head of the passenger P1. Since the passenger P1 included in the image IMG1 and the passenger P1 included in the image IMG2 are the same passenger, the tracking ID of the passenger P relating to the tracking area TA2 is the same as the tracking ID of the passenger P1 relating to the tracking area TA1. The tracking unit 314 calculates the position of the passenger P1, based on the tracking area TA2.

The tracking unit 314 registers, in the ID correspondence table 321, the position of the passenger P1 in association with the tracking ID relating to the passenger P1. In this instance, since the position of the passenger P1 calculated based on the tracking area TA1 is registered in the ID correspondence table 321, the position of the passenger P1 is updated, by the tracking unit 314 registering, in the ID correspondence table 321, the position of the passenger P1 calculated based on the tracking area TA2.

When setting the tracking area TA2, the tracking unit 314 may determine whether or not the face of the passenger P1 is included in the tracking area TA2. In other words, the tracking unit 314 may perform the face detection for the tracking area TA2. When it is determined that the face of the passenger P1 is included in the tracking area TA2, the tracking unit 314 generates a face image including the face area of the passenger P1. The tracking unit 314 transmits, to the face authentication unit 315, the generated face image in association with the tracking ID relating to the passenger P1. When it is determined that the face of the passenger P1 is not included in the tracking area TA2, the tracking unit 314 may not generate the face image. Even when it is determined that the face of the passenger P1 is included in the tracking area TA2, in a case where the tracking ID relating to the passenger P1 is associated with the authentication ID in the ID correspondence table 321 (i.e., in a case where the face authentication is successful), the tracking unit 314 may not generate the face image.

The face authentication unit 315 performs the face authentication processing, by using the face image transmitted from the tracking unit 314 and the face image registered in the face DB36. In a case where the face indicated by the face image transmitted from the tracking unit 314 corresponds to the face indicated by one of the face images registered in the face DB36 (in other words, in a case where the face authentication is successful), the face authentication unit 315 associates the authentication ID corresponding to one face image, with the tracking ID corresponding to the face image transmitted from the tracking unit 314, and registers it in the ID correspondence table 321. The face authentication unit 315 may register, in the ID correspondence table 321, an authentication time that is a time at which the face authentication processing is performed, in addition to the authentication ID. In a case where the authentication time is already registered in the ID correspondence table 321 (i.e., in a case where the face authentication was successful in the past), the face authentication unit 315 may update the authentication time registered in the ID correspondence table 321.

In a case where the face image indicating the face corresponding to the face indicated by the face image transmitted from the tracking unit 314 is not registered in the face DB36 (in other words, in a case where the face authentication is failed), the face authentication unit 315 may associate information indicating that there is no applicable person, with the tracking ID corresponding to the face image transmitted from the tracking unit 314, and may register it in the ID correspondence table 321.

The tracking unit 314 may identify the passenger P1 included in the image IMG3 by using the image IMG3 and the image IMG2. When the passenger P1 included in the image IMG3 is identified, the tracking unit 314 detects the head of the passenger P1. The tracking unit 314 sets the area including the head of the passenger P1, as a tracking area TA3, based on the detected head of the passenger P1. Since the passenger P1 included in the image IMG2 and the passenger P1 included in the image IMG3 are the same passenger, the tracking ID of the passenger P1 relating to the tracking area TA3 is the same as the tracking ID of the passenger P1 relating to the tracking area TA2. The tracking unit 314 calculates the position of the passenger P1, based on the tracking area TA3.

The tracking unit 314 registers, in the ID correspondence table 321, the position of the passenger P1 in association with the tracking ID relating to the passenger P1. In this instance, since the position of the passenger P1 calculated based on the tracking area TA2 is registered in the ID correspondence table 321, the position of the passenger P1 is updated, by the tracking unit 314 registering, in the ID correspondence table 321, the position of the passenger P1 calculated based on the tracking area TA3.

When setting the tracking area TA3, the tracking unit 314 may determine whether or not the face of the passenger P1 is included in the tracking area TA3. In other words, the tracking unit 314 may perform the face detection for the tracking area TA3. When it is determined that the face of the passenger P1 is included in the tracking area TA3, the tracking unit 314 generates a face image including the face area of the passenger P1. The tracking unit 314 transmits, to the face authentication unit 315, the generated face image in association with the tracking ID relating to the passenger P1. When it is determined that the face of the passenger P1 is not included in the tracking area TA3, the tracking unit 314 may not generate the face image. Even when it is determined that the face of the passenger P1 is included in the tracking area TA3, in a case where the tracking ID relating to the passenger P1 is associated with the authentication ID in the ID correspondence table 321 (i.e., in a case where the face authentication is already successful), the tracking unit 314 may not generate the face image.

The face authentication unit 315 performs the face authentication processing, by using the face image transmitted from the tracking unit 314 and the face image registered in the face DB36. In a case where the face indicated by the face image transmitted from the tracking unit 314 corresponds to the face indicated by one of the face images registered in the face DB36 (in other words, in a case where the face authentication is successful), the face authentication unit 315 associates the authentication ID corresponding to one face image, with the tracking ID corresponding to the face image transmitted from the tracking unit 314, and registers it in the ID correspondence table 321. The face authentication unit 315 may register, in the ID correspondence table 321, an authentication time that is a time at which the face authentication processing is performed, in addition to the authentication ID. In a case where the authentication time is already registered in the ID correspondence table 321 (i.e., in a case where the face authentication was successful in the past), the face authentication unit 315 may update the authentication time registered in the ID correspondence table 321.

In a case where the face image indicating the face corresponding to the face indicated by the face image transmitted from the tracking unit 314 is not registered in the face DB36 (in other words, in a case where the face authentication is failed), the face authentication unit 315 may associate information indicating that there is no applicable person, with the tracking ID corresponding to the face image transmitted from the tracking unit 314, and may register it in the ID correspondence table 321.

The tracking unit 314 and the face authentication unit 315 may repeat the above-described processing, until the passenger P1 passes through the authentication area RA. The tracking unit 314 calculates the position of the passenger P1 as described above. That is, it can be said that the tracking unit 314 detects the position of the passenger P1. Therefore, the tracking unit 314 may be referred to as a position detection unit.

Referring now to FIG. 8, an example of the ID correspondence table 321 will be described. As illustrated in FIG. 8, in the ID correspondence table 321, the tracking ID, a tracking position (e.g., the position of the passenger P1), the authentication ID, and the authentication time may be associated with each other. In the ID correspondence table 321, a case where the tracking ID is associated with a specific authentication ID, indicates that the face image of a person corresponding to the passenger having a set tracking ID is registered in the face DB36. A case where the tracking ID is associated with a character string of “N/A”, indicates that the face image of a person corresponding to the passenger having a set tracking ID is not registered in the face DB36. A case where the tracking ID is not associated with the authentication ID (i.e. a case where a field of the authentication ID is blank), indicates that the face authentication processing is not performed even once.

By the way, in some cases, it is hard for the tracking unit 314 to continue tracking the passenger P1, for example, as the head of the passenger P1 is hidden in behind others. When the tracking of the passenger P1 is lost, the tracking unit 314 may perform the following processing. After losing the tracking of the passenger P1, the tracking unit 314 may determine whether or not a new passenger is detected from the first image acquired by the image acquisition unit 311 (i.e., the first image generated by the camera CAM). The “new passenger” means a passenger whose tracking ID is not set.

When the new passenger is detected, the tracking unit 314 may determine whether or not the passenger P1 and the new passenger are the same person, by comparing the feature quantity of the tracking area relating to the passenger P1 (e.g., at least one of the tracking areas TA1, TA2 and TA3) with the feature quantity of the tracking area relating to the new passenger. When the passenger P1 and the new passenger are determined to be the same person, the tracking unit 314 may set the tracking ID relating to the passenger P1, for the new passenger. Consequently, the tracking unit 314 may track the passenger P1 again. Note that the feature quantity may be a feature quantity relating to the head of the passenger, a feature quantity relating to an upper body of the passenger, or a feature quantity relating to an entire body of the passenger. Accordingly, the tracking area may include the head of the passenger, may include the upper body of the passenger, or may include the entire body of the passenger. The feature quantity may be determined, for example, by a Person Re-Identification technique/technology.

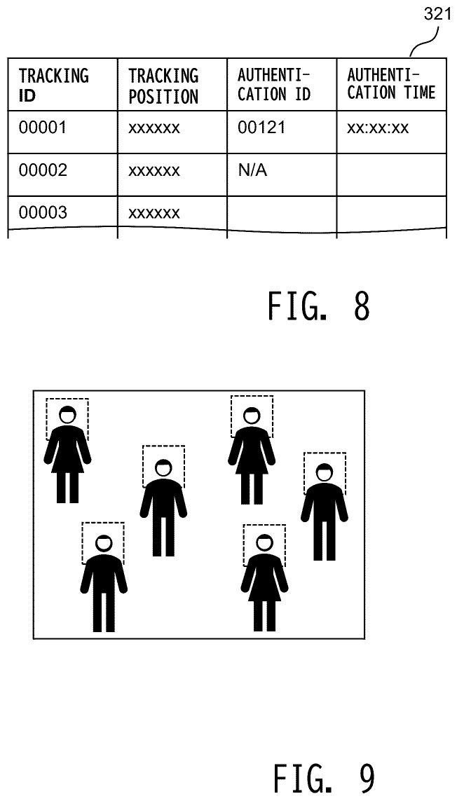

The tracking unit 314 and the face authentication unit 315 may perform the above-described tracking processing and face authentication processing, on each of the plurality of passengers included in the first image generated by the camera CAM. Here, the authentication area RA may be, for example, an area of 5 meters by 5 meters. A distance of 5 meters is long enough for 5 to 6 passengers to be permitted to pass side by side. In a case where the authentication area RA is an area of 5 meters by 5 meters, there may be 20 to 30 passengers in the authentication area RA. Therefore, the information processing apparatus 3 is configured to perform the tracking processing and the face authentication processing on the plurality of passengers, based on one first image generated by the camera CAM as illustrated in FIG. 9. Incidentally, a plurality of dotted squares in FIG. 9 represent the tracking area.

The tracking area (e.g., at least one of the tracking areas TA1, TA2 and TA3) may include a part other than the head of the passenger (e.g., a shoulder), in addition to the head of the passenger (e.g., the passenger P1) subjected to the tracking processing performed by the tracking unit 314. The tracking area may be set to include the upper body of the passenger, or may be set to include the entire body of the passenger.

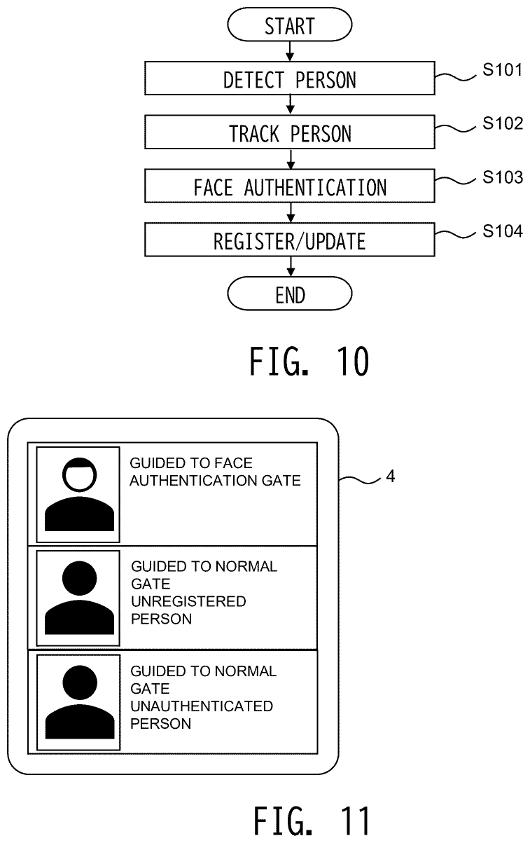

The operation of the tracking unit 314 and the face authentication unit 315 will be described with reference to a flowchart in FIG. 10. In FIG. 10, the tracking unit 314 detects one or more passengers (i.e., persons), from the first image acquired by the image acquisition unit 311 (i.e., the first image generated by the camera CAM) (step S101). In the step S101, the tracking unit 314 may detect the head of the passenger. In the step S101, the tracking unit 314 may set the tracking area including the head of the passenger detected, based on the head of the passenger detected. In the step S101, the tracking unit 314 may perform the face detection on the detected one or more passengers.

The tracking unit 314 performs the tracking processing on at least one of the one or more passengers detected in the step S101, by using another first image acquired by the image acquisition unit 311 (step S102). In the step S102, the tracking unit 314 may perform the face detection on the detected one or more passengers. In at least one of the steps S101 and S102, in a case where the face of at least one of the one or more passengers is detected, the tracking unit 314 transmits the face image including the face area of the at least one passenger, to the face authentication unit 315.

The face authentication unit 315 performs the face authentication processing by using the face image transmitted from the tracking unit 314 (step S103). The face authentication unit 315 registers a result of the face authentication processing in the ID correspondence table 321, or updates the ID correspondence table 321 based on the result of the face authentication processing (step S104).

Next, the operation of the determination unit 316 and the guidance unit 317 of the arithmetic apparatus 31 will be described. Here, a passenger P2 is used as an example. The determination unit 316 acquires a position of the passenger P2 from the ID correspondence table 321, based on the tracking ID relating to the passenger P2. The position of the passenger P2 may be represented by a value of the tracking position associated with the tracking ID relating to the passenger P2, in the ID correspondence table 321.

The determination unit 316 may determine whether or not the passenger P2 is permitted to pass through the face authentication gate apparatus 23, based on the ID correspondence table 321. In the ID correspondence table 321, in a case where the tracking ID relating to the passenger P2 is associated with a specific authentication ID, the determination unit 316 may determine that the passenger P2 is permitted to pass through the face authentication gate apparatus 23. In the ID correspondence table 321, in a case where the tracking ID relating to the passenger P2 is associated with the character string of “N/A”, or in a case where the tracking ID relating to the passenger P2 is not associated with the authentication ID (i.e., in a case where a field of the authentication ID is blank), the determining unit 316 may determine that the passenger P2 is not permitted to pass through the face authentication gate apparatus 23.

When it is determined that the passenger P2 is permitted to pass through the face authentication gate apparatus 23, the determination unit 316 may determine that the passenger P2 uses the face authentication gate apparatus 23. The determination unit 316 acquires information about the area Ar1 (e.g., information indicating at least one of the position and size of the area Ar1) associated with the apparatus identification information about the face authentication gate apparatus 23. The determination unit 316 may acquire the information about area Ar1 from the setting unit 313.

The determination unit 316 determines whether or not the passenger P2 is in the area Ar1, based on the position of the passenger P2 and the information about the area Ar1. As described above, the area Ar1 is an area including at least a part of the path with a flow of people heading toward the face authentication gate apparatus 23. When it is determined that the passenger P2 is in the area Ar1, the determination unit 316 determines that the passenger P2 is heading toward the face authentication gate apparatus 23. When it is determined that the passenger P2 is not in the area Ar1, the determination unit 316 determines that the passenger P2 is not heading toward the face authentication gate apparatus 23. In this instance, the determination unit 316 transmits, to the guidance unit 317, information indicating the passenger P2 and information indicating the gate apparatus to be used by the passenger P2.

The guidance unit 317 may transmit the information indicating the passenger P2 and the information indicating the gate apparatus to be used by the passenger P2, to a terminal apparatus 4 (see FIG. 11) that is used by the airport staff (e.g., at least one of a guide and a security guard) near the boarding gate G1. As a consequence, a window/screen as illustrated in FIG. 11 may be displayed on the terminal apparatus 4. The airport staff may guide the passenger P2 to the face authentication gate apparatus 23, based on the information displayed on the terminal authentication 4.

The information processing apparatus 3 may be connected to the terminal apparatus 4 via the network NW. The terminal apparatus 4 may be configured by any of a tablet terminal, a smart phone, and a notebook PC (Personal Computer).

When it is determined that the passenger P2 is not permitted to pass through the face authentication gate apparatus 23, the determination unit 316 may determine that the passenger P2 uses the normal gate apparatus 24a or 24b. The determination unit 316 acquires information about the area Ar2 (e.g., information indicating at least one of the position and size of the area Ar2) associated with the apparatus identification information about the normal gate apparatus 24a or 24b. The determination unit 316 may acquire the information about the area Ar2 from the setting unit 313.

The determination unit 316 determines whether or not the passenger P2 is in the area Ar2, based on the position of the passenger P2 and the information about the area Ar2. As described above, the area Ar2 is an area including at least a part of the path with a flow of people heading toward the normal gate apparatuses 24a and 24b. When it is determined that the passenger P2 is in the area Ar2, the determination unit 316 determines that the passenger P2 is heading toward one of the normal gate apparatuses 24a and 24b. When it is determined that the passenger P2 is not in the area Ar2, the determination unit 316 determines that the passenger P2 is not heading toward the normal gate apparatuses 24a and 24b. In this instance, the determination unit 316 transmits, to the guidance unit 317, the information indicating the passenger P2 and the information indicating the gate apparatus to be used by the passenger P2.

The guidance unit 317 may transmit, to the terminal apparatus 4, the information indicating the passenger P2 and the information indicating the gate apparatus to be used by the passenger P2. The airport staff may guide the passenger P2 to one of the normal gate apparatuses 24a and 24b, based on the information displayed on terminal apparatus 4.

In place of or in addition to transmitting, to the terminal apparatus 4, the information indicating the passenger P2 and the information indicating the gate apparatus to be used by the passenger P2, the guidance unit 317 may emit a sound/audio for guiding the passenger P2 to the face authentication gate apparatus 23 via a not-illustrated speaker, or may project an image for guiding the passenger P2 to the face authentication gate apparatus 23 via a not-illustrated projection apparatus, for example. The guidance unit 317 may transmit the information indicating the gate apparatus to be used by the passenger P2, to a portable terminal (e.g., at least one of a smart phone and a tablet terminal) carried by the passenger P2, for example.

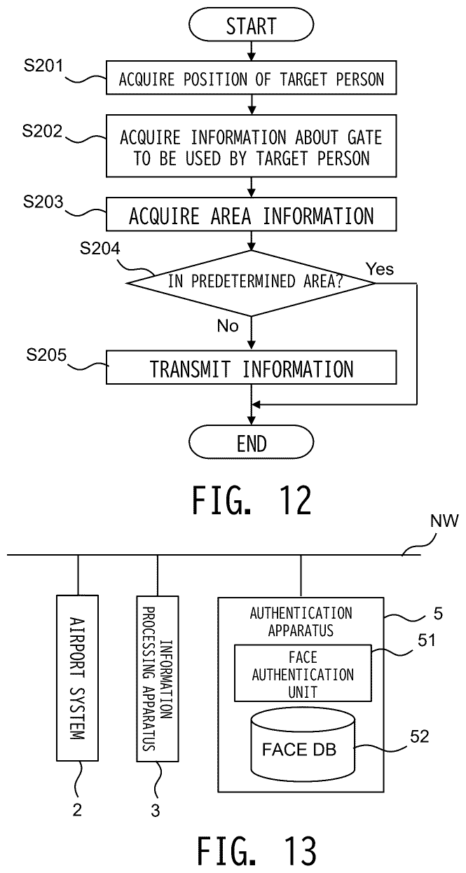

The operation of the determination unit 316 will be described with reference to a flowchart in FIG. 12. In FIG. 12, the determination unit 316 acquires the position of the passenger from the ID correspondence table 321, based on the tracking ID relating to the passenger (e.g., the passenger P2) serving as the target person (step S201). The determination unit 316 may determine the gate apparatus to be used by the passenger, based on the tracking ID relating to the passenger and the ID correspondence table 321. The determination unit 316 acquires the apparatus identification information about the gate apparatus to be used by the passenger (step S202).

The determination unit 316 acquires the information about the area (e.g., one of the areas Ar1 and Ar2) associated with the gate apparatus to be used by the passenger, based on the apparatus identification information acquired in the step S202 (step S203). The determination unit 316 determines whether or not the passenger is in a predetermined arear, based on the position of the passenger acquired in the step S201 and the information about area acquired in the step S203 (step S204). Here, the “predetermined area” means an area associated with the gate apparatus to be used by the passenger.

In the step S204, when it is determined that the passenger is in the predetermined area (the step S204: Yes), the determination unit 316 may change the target person (e.g., change from one passenger to another) and may perform the processing in the step S201. In the step S204, when it is determined that the passenger is not in the predetermined area (the step S204: No), the determination unit 316 may transmit, to the guidance unit 317, the information indicating the passenger and the information indicating the gate apparatus to be used by the passenger (step S205). Thereafter, the determination unit 316 may change the target person, and may perform the processing in the step S201.

The determination unit 316 may determine whether or not the gate apparatus is in operation, based on the boarding gate information. The operation of the information processing apparatus 3 described above may be realized by the information processing apparatus 3 reading a computer program recorded on a recording medium. In such a case it can be said that a computer program that allows the information processing apparatus 3 to execute the above-described operation is recorded on the recording medium.

### Technical Effect

The information processing apparatus 3 determines whether or not each of the plurality of passengers is hearing toward the gate apparatus to be used, based on the position of each of the plurality of passengers and the information about the area (e.g., one of the areas Ar1 and Ar2) associated with the gate apparatus to be used by each of the plurality of passengers. The information processing apparatus 3 may transmit, for example, to the terminal apparatus, information indicating one or more of the plurality of passengers not heading toward the gate apparatus to be used and information indicating the gate apparatus to be used by the one or more passenger.

For example, in a case where the airport staff (e.g., at least one of a guide and a security guard) can judge the person not being permitted to pass through the face authentication gate apparatus 23, based on the information displayed on the terminal apparatus 4, the airport staff can guide the person not being permitted to pass through the face authentication gate apparatus 23, so as to enter the face authentication gate apparatus 23. Therefore, according to the information processing apparatus 3, it is possible to prevent the person not being permitted to pass through the face authentication gate apparatus 23, from entering the face authentication gate apparatus 23. Therefore, according to the information processing apparatus 3, it is possible to prevent/control the reduction in the throughput of the face authentication gate apparatus 23.

In addition to the boarding gate at the airport, the information processing apparatus 3 may be applied to at least one of a security gate at the airport (i.e., a gate disposed in a security inspection site at the airport) and an immigration gate, for example. In addition to the airport, the information processing apparatus 3 may be applied to at least one of offices, railroad stations, theme parks, and event venues using the face authentication gate apparatus for at least one of entrance and exit, for example.

### First Modification

In the above-described second example embodiment, the information processing apparatus 3 (specifically, the face authentication unit 315) performs the face authentication processing. The information processing apparatus 3, however, may not perform the face authentication processing. In this instance, the information processing apparatus 3 may not include the face authentication unit 315 and the face DB36. In this instance, the face authentication processing may be performed by an authentication apparatus 5 differing from the information processing apparatus 3. In such a case, as illustrated in FIG. 13, the information processing apparatus 3 and the authentication apparatus 5 may be connected via the network NW. The information processing apparatus 3 and the authentication apparatus 5 may constitute one system. The one system may be referred to as an information processing system or an authentication system.

The authentication apparatus 5 includes a face authentication unit 51 and a face database 52 (hereinafter referred to as a “face DB52”). The face authentication unit 51 is configured to perform the face authentication processing. That is, the authentication apparatus 5 is an authentication apparatus having a face authentication function. The management server 21 of the airport system 2 may transmit, to the authentication apparatus 5, at least a part of the face image registered in the face DB 211, together with the authentication ID (i.e., the passenger identification information) added to the face image. In this instance, the management server 21 may transmit the gate identification information and the boarding start time to the authentication apparatus 5, in addition to the face image. The authentication apparatus 5 may register, in the face DB52, the face image transmitted from the management server 21. In addition to the face image, the authentication apparatus 5 may register, in the face DB52, the gate identification information and the boarding start time.

The tracking unit 312 of the information processing apparatus 3 may detect the passenger (e.g., the passenger P1) included in the image acquired by the image acquisition unit 311. The tracking unit 312 may set the tracking area including the head of the passenger detected. The tracking unit 312 may perform the face detection on the detected passenger. In a case where the face of the passenger is detected, the tracking unit 314 may transmit the face image including the face area of the passenger, to the authentication apparatus 5 via the communication apparatus 33.

The face authentication unit 51 of the authentication apparatus 5 may perform the face authentication processing, by using the face image transmitted from the information processing apparatus 3 (specifically, the tracking unit 314) and the face DB52. The face authentication unit 51 may transmit information indicating a result of the face authentication processing, to the information processing apparatus 3. The information processing apparatus 3 may register, in the ID correspondence table 321, the result of the face authentication processing indicated by the information transmitted from the authentication apparatus 5 (specifically, the face authentication part 51).

### Second Modification

In addition to the position of the passenger and the area (e.g., one of the areas Ar1 and area Ar2) associated with the gate apparatus to be used by the passenger, the determination unit 316 may determine whether or not to transmit, to the guidance unit 317, the information indicating the passenger and the information indicating the boarding gate information to be used by the passenger, based on a moving direction of the passenger.

For example, when it is determined that the passenger P2 is permitted to pass through the face authentication gate apparatus 23, the determination unit 316 may determine that the passenger P2 uses the face authentication gate apparatus 23. The determination unit 316 acquires the information about the area Ar1 (e.g., the information indicating at least one of the position and size of the area Ar1) associated with the apparatus identification information about the face authentication gate apparatus 23. The determination unit 316 may estimate a moving direction of the passenger P2, based on a change in the position of the passenger P2.

The determination unit 316 determines whether or not the passenger P2 is in the area Ar1, based on the position of the passenger P2 and the information about the area Ar1. When it is determined that the passenger P2 is in the area Ar1, the determination unit 316 may determine whether or not the moving direction of the passenger P2 is a direction toward the face authentication gate apparatus 23. When it is determined that the moving direction of the passenger P2 is the direction toward the face authentication gate apparatus 23, the determination unit 316 may determine that the passenger P2 is heading toward the face authentication gate apparatus 23.

When it is determined that the moving direction of the passenger P2 is not the direction toward the face authentication gate apparatus 23, the determination unit 316 may determine that the passenger P2 is not heading toward the face authentication gate apparatus 23. In this instance, the determination unit 316 may transmit, to the guidance unit 317, the information indicating the passenger P2 and the information indicating the gate apparatus to be used by the passenger P2.

Alternatively, when it is determined that the passenger P2 is in the area Ar1, the determination unit 316 may determine whether or not the moving direction of the passenger P2 is a direction toward an end of a line/queue formed by passengers waiting to pass through the face authentication gate apparatus 23. When it is determined that the moving direction of the passenger P2 is the direction toward the end of the line, the determination unit 316 may determine that the passenger P2 is heading toward the face authentication gate apparatus 23.

When it is determined that the moving direction of the passenger P2 is not the direction toward the end of the line, the determination unit 316 may determine that the passenger P2 is not heading toward the face authentication gate apparatus 23. In this instance, the determination unit 316 may transmit, to the guidance unit 317, the information indicating the passenger P2 and the information indicating the gate apparatus to be used by the passenger P2.

When it is determined that the passenger P2 is not in the area Ar1, the determination unit 316 may determine whether or not the moving direction of the passenger P2 is a direction toward the face authentication gate apparatus 23. When it is determined that the moving direction of the passenger P2 is the direction toward the face authentication gate apparatus 23, the determination unit 316 may determine that the passenger P2 is heading toward the face authentication gate apparatus 23.

When it is determined that the moving direction of the passenger P2 is not the direction toward the face authentication gate apparatus 23, the determination unit 316 may determine that the passenger P2 is not heading toward the face authentication gate apparatus 23. In this instance, the determination unit 316 may transmit, to the guidance unit 317, the information indicating the passenger P2 and the information indicating the gate apparatus to be used by the passenger P2.

Alternatively, when it is determined that the passenger P2 is not in the area Ar1, the determination unit 316 may determine whether or not the moving direction of the passenger P2 is a direction toward an end of a line formed by passengers waiting to pass through the face authentication gate apparatus 23. When it is determined that the moving direction of the passenger P2 is the direction toward the end of the line, the determination unit 316 may determine that the passenger P2 is heading toward the face authentication gate apparatus 23.

When it is determined that the moving direction of the passenger P2 is not the direction toward the end of the line, the determination unit 316 may determine that the passenger P2 is not heading toward the face authentication gate apparatus 23. In this instance, the determination unit 316 may transmit, to the guidance unit 317, the information indicating the passenger P2 and the information indicating the gate apparatus to be used by the passenger P2.

When it is determined that the passenger P2 is not permitted to pass through the face authentication gate apparatus 23, the determination unit 316 may determine that the passenger P2 uses the normal gate apparatus 24a or 24b. The determination unit 316 acquires the information about the area Ar2 (e.g., the information indicating at least one of the position and the size of the area Ar2) associated with the apparatus identification information about the normal gate apparatus 24a or 24b. The determination unit 316 may estimate the moving direction of the passenger P2, based on the change in the position of the passenger P2.

The determination unit 316 determines whether or not the passenger P2 is in the area Ar2, based on the position of the passenger P2 and the information about the area Ar2. When it is determined that the passenger P2 is in the area Ar2, the determination unit 316 may determine whether or not the moving direction of the passenger P2 is a direction toward one of the normal gate apparatuses 24a and 24b. When it is determined that the moving direction of the passenger P2 is the direction toward one of the normal gate apparatuses 24a and 24b, the determination unit 316 may determine that the passenger P2 is heading toward one of the normal gate apparatuses 24a and 24b.

When it is determined that the moving direction of the passenger P2 is not the direction toward one of the normal gate apparatuses 24a and 24b, the determination unit 316 may determine that the passenger P2 is not heading toward the normal gate apparatuses 24a and 24b. In this instance, the determination unit 316 may transmit, to the guidance unit 317, the information indicating the passenger P2 and the information indicating the gate apparatus to be used by the passenger P2.

Alternatively, when it is determined that the passenger P2 is in the area Ar2, the determination unit 316 may determine whether the moving direction of the passenger P2 is a direction toward an end of a line formed by passengers waiting to pass through one of the normal gate apparatuses 24a and 24b. When it is determined that the moving direction of the passenger P2 is the direction toward the end of the line, the determination unit 316 may determine that the passenger P2 is heading toward one of the normal gate apparatuses 24a and 24b.

When it is determined that the moving direction of the passenger P2 is not the direction toward the end of the line, the determination unit 316 may determine that the passenger P2 is not normally toward heading toward the normal gate apparatuses 24a and 24b. In this instance, the determination unit 316 may transmit, to the guidance unit 317, the information indicating the passenger P2 and the information indicating the gate apparatus to be used by the passenger P2.

When it is determined that the passenger P2 is not in the area Ar2, the determination unit 316 may determine whether or not the moving direction of the passenger P2 is a direction toward one of the normal gate apparatuses 24a and 24b. When it is determined that the moving direction of the passenger P2 is the direction toward one of the normal gate apparatuses 24a and 24b, the determination unit 316 may determine that the passenger P2 is heading toward one of the normal gate apparatuses 24a and 24b.

When it is determined that the moving direction of the passenger P2 is not the direction toward one of the normal gate apparatuses 24a and 24b, the determination unit 316 may determine that the passenger P2 is not heading toward the normal gate apparatuses 24a and 24b. In this instance, the determination unit 316 may transmit, to the guidance unit 317, the information indicating the passenger P2 and the information indicating the gate apparatus to be used by the passenger P2.

Alternatively, when it is determined that the passenger P2 is not in the area Ar2, the determination unit 316 may determine whether or not the moving direction of the passenger P2 is a direction toward an end of a line formed by passengers waiting to pass through one of the normal gate apparatuses 24a and 24b. When it is determined that the moving direction of the passenger P2 is the direction toward the end of the line, the determination unit 316 may determine that the passenger P2 is heading toward one of the normal gate apparatuses 24a and 24b.

When it is determined that the moving direction of the passenger P2 is not the direction toward the end of the line, the determination unit 316 may determine that the passenger P2 is not heading toward the normal gate apparatuses 24a and 24b. In this instance, the determination unit 316 may transmit, to the guidance unit 317, the information indicating the passenger P2 and the information indicating the gate apparatus to be used by the passenger P2.

### Third Modification

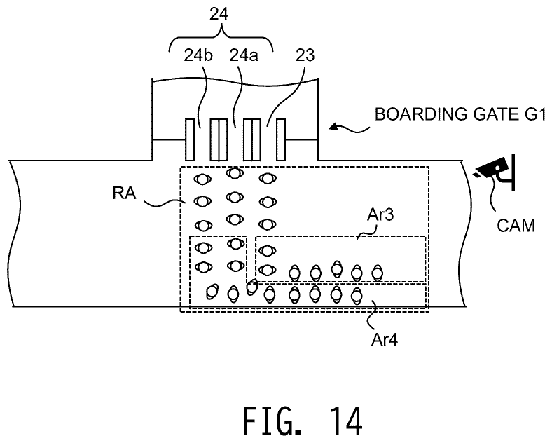

As illustrated in FIG. 14, at least one of a first line formed by passengers waiting to pass through the face authentication gate apparatus 23 and a second line formed by passengers waiting to pass through one of the normal gate apparatuses 24a and 24b, may be crooked or not straight in the middle. In this instance, the setting unit 313 may set an area Ar3 including at least a part of the first line (i.e., an area corresponding to the area Ar1 in FIG. 4), based on a shape of the first line. The setting unit 313 may also set an area Ar4 including at least a part of the second line (i.e., an area corresponding to the area Ar2 in FIG. 4), based on a shape of the second line.

The setting unit 313 may estimate the shape of at least one of the first line and the second line, based on a plurality of images acquired by the image acquisition unit 311. For example, the setting unit 313 may calculate a plurality of trajectories respectively corresponding to a plurality of passengers, based on a change in each of the positions of the plurality of passengers included in the images. The setting unit 313 may estimate the shape of at least one of the first line and the second line, based on the plurality of trajectories. In addition to or in place of the plurality of trajectories, the setting unit 313 may estimate the shape of at least one of the first line and the second line, based on an array of partition poles included in the images.

### Fourth Modification

In a case where one aircraft and another aircraft depart from a certain boarding gate (e.g., the boarding gate G1), after the departure of the one aircraft, the gate apparatus may not be operated until the boarding announcement of the other aircraft is started (e.g., until the boarding start time of the other aircraft), even though a power supply of the gate apparatus is ON (i.e., even though the gate apparatus is in the active state).

The setting unit 313 may set the area (e.g., at least one of the areas Ar1 and Ar2), based on the operating status of the gate apparatus and the operation information about aircrafts. The setting unit 313 may identify a time zone in which the gate apparatus is not operated, based on the operation information about aircrafts. In the time zone in which the gate apparatus is not operated, the setting unit 313 may not set the area (e.g., at least one of the areas Ar1 and Ar2) even if the operating status of the gate apparatus is the active state. In this instance, the information processing apparatus 3 may not perform the tracking processing and the face authentication processing described above, in the time zone in which the gate apparatus is not operated. That is, the information processing apparatus 3 may stop the functions relating to the tracking processing and the face authentication processing, in the time zone in which the gate apparatus is not operated.

### Third Example Embodiment

An information processing apparatus according to a third example embodiment will be described. The following describes an information processing apparatus, an information processing method, and a recording medium according to the third example embodiment, by using an information processing apparatus 3. The third example embodiment differs from the second example embodiment, in a part of the operation of the setting unit 313 and the determination unit 316. The third example embodiment may be the same as the second example embodiment in the other points.

The setting unit 313 may not set a virtual area (e.g., at least one of the areas Ar1 and Ar3) including at least a part of the path with a flow of people heading toward the face authentication gate apparatus 23, and a virtual area (e.g., at least one of the areas Ar2 and Ar4) including at least a part of the path with a flow of people heading toward the normal gate apparatuses 24a and 24b.

The setting unit 313 may identify the first line formed by passengers waiting to pass through the face authentication gate apparatus 23 and the second line formed by passengers waiting to pass through one of the normal gate apparatuses 24a and 24b. The setting unit 313 may identify at least one of the first line and the second line, based on a plurality of images acquired by the image acquisition unit 311. For example, the setting unit 313 may calculate a plurality of trajectories respectively corresponding to a plurality of passengers, based on the change in each of the positions of the plurality of passengers included in the images. The setting unit 313 may identify at least one of the first line and the second line, based on the plurality of trajectories.

Alternatively, the setting unit 313 may identify the first line, not based on the line actually formed by passengers, but based on at least one of the position and direction/orientation of the face authentication gate apparatus 23, for example. Similarly, the setting unit 313 may identify the second line, based on at least one of the position and direction/orientation of at least one of the normal gate apparatuses 24a and 24b, for example.

The operation of the determination unit 316 will be described, with a passenger P3 exemplified. The determination unit 316 may determine whether or not the passenger P3 is permitted to pass through the face authentication gate apparatus 23, based on the ID correspondence table 321. When it is determined that the passenger P3 is permitted to pass through the face authentication gate apparatus 23, the determination unit 316 may determine that the passenger P3 uses the face authentication gate apparatus 23. The determination unit 316 may determine whether or not a moving direction of the passenger P3 based on a change in the position of the passenger P3 is a direction toward an end of the first line (i.e., the line formed by passengers waiting to pass through the face authentication gate apparatus 23).

When the moving direction of the passenger P3 is the direction toward the end of the first line, the determination unit 316 may determine that the passenger P3 is heading toward the face authentication gate apparatus 23. When the moving direction of the passenger P3 is not the direction toward the end of the first line, the determination unit 316 may determine that the passenger P3 is not heading toward the face authentication gate apparatus 23. In this instance, the determination unit 316 may transmit, to the guidance unit 317, information indicating the passenger P3 and information indicating the gate apparatus to be used by the passenger P3.

When it is determined that the passenger P3 is not permitted to pass through the face authentication gate apparatus 23, the determination unit 316 may determine that the passenger P3 uses one of the normal gate apparatuses 24a and 24b. The determination unit 316 may determine whether or not the moving direction of the passenger P3 based on the change in the position of the passenger P3 is a direction toward an end of the second line (i.e., the line formed by passengers waiting to pass through one of the normal gate apparatuses 24a and 24b).

When the moving direction of the passenger P3 is the direction toward the end of the second line, the determination unit 316 may determine that the passenger P3 is heading toward one of the normal gate apparatuses 24a and 24b. When the moving direction of the passenger P3 is not the direction toward the end of the second line, the determination unit 316 may determine that the passenger P3 is not heading toward the normal gate apparatuses 24a and 24b. In this instance, the determination unit 316 may transmit, to the guidance unit 317, the information indicating the passenger P3 and the information indicating the gate apparatus to be used by the passenger P3.

The operation of the information processing apparatus 3 described above may be realized by the information processing apparatus 3 reading a computer program recorded on a recording medium. In such a case it can be said that a computer program that allows the information processing apparatus 3 to execute the above-described operation is recorded on the recording medium.

### Technical Effect

According to the information processing apparatus 3, it is possible to prevent the person not being permitted to pass through the face authentication gate apparatus 23, from entering the face authentication gate apparatus 23. Therefore, according to the information processing apparatus 3, it is possible to prevent/control the reduction in the throughput of the face authentication gate apparatus 23.

### Supplementary Notes

With respect to the example embodiment described above, the following Supplementary Notes are further disclosed.

### Supplementary Note 1

An information processing apparatus including:
a setting unit that sets a first area including at least a part of a path with a flow of people heading toward a face authentication gate apparatus, based on gate information about a plurality of gate apparatuses including the face authentication gate apparatus;
an image acquisition unit that acquires a first image including the first area; and
a first determination unit that determines whether or not a first authentication subject, who is a person included in the acquired first image and located in the first area, is permitted to pass through the face authentication gate apparatus, based on a result of face authentication performed on the first authentication subject by using the acquired first image.

### Supplementary Note 2

The information processing apparatus according to Supplementary Note 1, wherein the information processing apparatus includes an output unit that outputs first authentication subject information indicating the first authentication subject, in response to a determination by the first determination unit that the first authentication subject is not permitted to pass through the face authentication gate apparatus.

### Supplementary Note 3

The information processing apparatus according to Supplementary Note 2, wherein the information processing apparatus includes:
a detection unit that detects a change in a position of the first authentication subject, based on a plurality of first images acquired by the image acquisition unit; and
a second determination unit that determines whether or not to output the first authentication subject information, based on the change in the position of the first authentication subject, and
the output unit outputs the first patient authentication information, in response to the determination by the first determination unit that the first authentication subject is not permitted to pass through the face authentication gate apparatus, and in response to a determination by the second determination unit to output the first authentication subject information.

### Supplementary Note 4

The information processing apparatus according to Supplementary Note 3, wherein the second determination unit determines to output the first authentication subject information, in response to the determination by the first determination unit that the first authentication subject is not permitted to pass through the face authentication gate apparatus, and in a case where a moving direction of the first authentication subject based on the change in the position of the first authentication subject is a direction toward the face authentication gate apparatus.

### Supplementary Note 5

The information processing apparatus according to Supplementary Note 3, wherein the second determination unit determines to output the first authentication subject information, in response to a determination by the first determination unit that the first authentication subject is not permitted to pass through the face authentication gate apparatus, and in a case where a moving direction of the first authentication subject based on the change in the position of the first authentication subject is a direction toward an end of a line formed by people waiting to pass through the face authentication gate apparatus.

### Supplementary Note 6

The information processing apparatus according to any one of Supplementary Notes 1 to 5, wherein the gate information includes position information indicating a position of the face authentication gate apparatus.

### Supplementary Note 7

The information processing apparatus according to any one of Supplementary Notes 1 to 6, wherein the information processing apparatus includes an authentication unit that performs face authentication by using the first image acquired by the image acquisition unit.

### Supplementary Note 8

The information processing apparatus according to any one of Supplementary Notes 1 to 7, wherein
the plurality of gate apparatuses include another gate apparatus that differs from the face authentication gate apparatus,
the setting unit sets a second area including at least a part of a path with a flow of people heading toward the other gate apparatus, based on the gate information,
the image acquisition unit acquires a second image including the second area, and
the first determination unit determines whether or not a second authentication subject, who is a person included in the acquired second image and located in the second area, is permitted to pass through the face authentication gate apparatus, based on a result of face authentication performed on the second authentication subject by using the acquired second image.

### Supplementary Note 9

The information processing apparatus according to Supplementary Note 8, wherein the information processing apparatus includes an output unit that outputs second authentication subject information indicating the second authentication subject, in response to a determination by the first determination unit that the second authentication subject is permitted to pass through the face authentication gate apparatus.

### Supplementary Note 10

The information processing apparatus according to Supplementary Note 9, wherein the information processing apparatus includes:
a detection unit that detects a change in a position of the second authentication subject, based on a plurality of second images acquired by the image acquisition unit; and
a second determination unit that determines whether or not to output the second authentication subject information, based on the change in the position of the second authentication subject, and
the output unit outputs the second authentication subject information, in response to the determination by the first determination unit that the second authentication subject is permitted to pass through the face authentication gate apparatus, and in response to a determination by the second determination unit to output the second authentication subject information.

### Supplementary Note 11

The information processing apparatus according to Supplementary Note 10, wherein the second determination unit determines to output the second authentication subject, in response to the determination by the first determination unit that the second authentication subject is permitted to pass through the face authentication gate apparatus, and in a case where a moving direction of the second authentication subject based on the change in the position of the second authentication subject is not a direction toward the face authentication gate apparatus.

### Supplementary Note 12

The information processing apparatus according to Supplementary Note 10, wherein the second determination unit determines to output the second authentication subject, in response to the determination by the first determination unit that the second authentication subject is permitted to pass through the face authentication gate apparatus, and in a case where a moving direction of the second authentication subject based on the change in the position of the second authentication subject is not a direction toward an end of a line formed by people waiting to pass through the face authentication gate apparatus.

### Supplementary Note 13

An information processing method including:
setting a first area including at least a part of a path with a flow of people heading toward a face authentication gate apparatus, based on gate information about a plurality of gate apparatuses including the face authentication gate apparatus;
acquiring a first image including the first area; and
determining whether or not a first authentication subject, who is a person included in the acquired first image and located in the first area, is permitted to pass through the face authentication gate apparatus, based on a result of face authentication performed on the first authentication subject by using the acquired first image.

### Supplementary Note 14

A recording medium on which a computer program that allows a computer to execute an information processing method is recorded, the information processing method including:
setting a first area including at least a part of a path with a flow of people heading toward a face authentication gate apparatus, based on gate information about a plurality of gate apparatuses including the face authentication gate apparatus;
acquiring a first image including the first area; and
determining whether or not a first authentication subject, who is a person included in the acquired first image and located in the first area, is permitted to pass through the face authentication gate apparatus, based on a result of face authentication performed on the first authentication subject by using the acquired first image.

### Supplementary Note 15

An information processing apparatus including:
a path identification unit that identifies a path with a flow of people heading toward a face authentication gate apparatus;
an image acquisition unit that acquires a third image including the identified path;
a position detection unit that detects a position of a third authentication subject included in the third image, based on the acquired third image;
a first determination unit that determines whether or not the third authentication subject is permitted to pass through the face authentication gate apparatus, based on a result of face authentication performed on the third authentication subject by using the acquired third image; and
a second determination unit that determines whether or not to output third authentication subject information indicating the third authentication subject, on the basis of a moving direction of the third authentication subject based on a change in a position of the third authentication subject, and on the basis of the identified path, in response to a determination by the first determination unit that the third authentication subject is not permitted to pass through the face authentication gate apparatus.

### Supplementary Note 16

An information processing system including:
a face authentication gate apparatus;
a setting unit that sets a first area including at least a part of a path with a flow of people heading toward the face authentication gate apparatus, based on gate information about a plurality of gate apparatuses including the face authentication gate apparatus;
an image acquisition unit that acquires a first image including the first area;
a first determination unit that determines whether or not a first authentication subject, who is a person included in the acquired first image and located in the first area, is permitted to pass through the face authentication gate apparatus, based on a result of face authentication performed on the first authentication subject by using the acquired first image; and
an authentication unit that performs face authentication by using the acquired first image.

The present disclosure is not limited to the example embodiments described above, but is allowed to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

1, 3 Information processing apparatus
2 Airport system
4 Terminal apparatus
5 Authentication apparatus
11, 311 Image acquisition unit
12, 313 Setting unit
13, 316 Determination unit
21 Management server
22 Check-in terminal
23 Face authentication gate apparatus
24 Normal gate apparatus
31 Arithmetic apparatus
32 Storage apparatus
33 Communication apparatus
34 Input apparatus
35 Output apparatus
36, 52, 211, 232 Face database
51, 315 Face authentication unit
312 Information acquisition unit
314 Tracking unit

What is claimed is:

1. An information processing apparatus comprising:
at least one memory configured to store instructions, and
at least one processor configured to execute the instructions to:
set a first area including at least a part of a path with a flow of people heading toward a face authentication gate apparatus, based on gate information about a plurality of gate apparatuses including the face authentication gate apparatus;
acquire a first image including the first area; and
determine whether or not a first authentication subject, who is a person included in the acquired first image and located in the first area, is permitted to pass through the face authentication gate apparatus, based on a result of face authentication performed on the first authentication subject by using the acquired first image.

2. The information processing apparatus according to claim 1, wherein the at least one processor is configured to execute the instructions to output first authentication subject information indicating the first authentication subject, in response to a determination that the first authentication subject is not permitted to pass through the face authentication gate apparatus.

3. The information processing apparatus according to claim 2, wherein the at least one processor is configured to execute the instructions to:
detect a change in a position of the first authentication subject, based on a plurality of first images;
determine whether or not to output the first authentication subject information, based on the change in the position of the first authentication subject; and
output the first authentication subject information, in response to the determination that the first authentication subject is not permitted to pass through the face authentication gate apparatus, and in a case where a moving direction of the first authentication subject based on the change in the position of the first authentication subject is a direction toward the face authentication gate apparatus.

4. (canceled)

5. The information processing apparatus according to claim 2, wherein the at least one processor is configured to execute the instructions to:
detect a change in a position of the first authentication subject, based on a plurality of first images;
determine whether or not to output the first authentication subject information, based on the change in the position of the first authentication subject; and
determine to output the first authentication subject information, in response to a determination that the first authentication subject is not permitted to pass through the face authentication gate apparatus, and in a case where a moving direction of the first authentication subject based on the change in the position of the first authentication subject is a direction toward an end of a line formed by people waiting to pass through the face authentication gate apparatus.

6. The information processing apparatus according to claim 1, wherein the gate information includes position information indicating a position of the face authentication gate apparatus.

7. The information processing apparatus according to claim 1, wherein the at least one processor is configured to execute the instructions to perform face authentication by using the first image.

8. The information processing apparatus according to claim 1, wherein
the plurality of gate apparatuses include another gate apparatus that differs from the face authentication gate apparatus,
the at least one processor is configured to execute the instructions to:
set a second area including at least a part of a path with a flow of people heading toward the other gate apparatus, based on the gate information,
acquire a second image including the second area, and
determine whether or not a second authentication subject, who is a person included in the acquired second image and located in the second area, is permitted to pass through the face authentication gate apparatus, based on a result of face authentication performed on the second authentication subject by using the acquired second image.

9. The information processing apparatus according to claim 8, wherein the at least one processor is configured to execute the instructions to output second authentication subject information indicating the second authentication subject, in response to a determination that the second authentication subject is permitted to pass through the face authentication gate apparatus.

10. The information processing apparatus according to claim 9, wherein the at least one processor is configured to execute the instructions to:
detect a change in a position of the second authentication subject, based on a plurality of second images;
determine whether or not to output the second authentication subject information, based on the change in the position of the second authentication subject; and
output the second authentication subject, in response to the determination that the second authentication subject is permitted to pass through the face authentication gate apparatus, and in a case where a moving direction of the second authentication subject based on the change in the position of the second authentication subject is not a direction toward the face authentication gate apparatus.

11. (canceled)

12. The information processing apparatus according to claim 9, wherein at least one processor is configured to execute the instructions to:
detect a change in a position of the second authentication subject, based on a plurality of second images;
determine whether or not to output the second authentication subject information, based on the change in the position of the second authentication subject; and
determine to output the second authentication subject, in response to the determination that the second authentication subject is permitted to pass through the face authentication gate apparatus, and in a case where a moving direction of the second authentication subject based on the change in the position of the second authentication subject is not a direction toward an end of a line formed by people waiting to pass through the face authentication gate apparatus.

13. An information processing method comprising:
setting a first area including at least a part of a path with a flow of people heading toward a face authentication gate apparatus, based on gate information about a plurality of gate apparatuses including the face authentication gate apparatus;
acquiring a first image including the first area; and
determining whether or not a first authentication subject, who is a person included in the acquired first image and located in the first area, is permitted to pass through the face authentication gate apparatus, based on a result of face authentication performed on the first authentication subject by using the acquired first image.

14. A non-transitory recording medium on which a computer programs that allows a computer to execute an information processing method is recorded, the information processing method including:
setting a first area including at least a part of a path with a flow of people heading toward a face authentication gate apparatus, based on gate information about a plurality of gate apparatuses including the face authentication gate apparatus;
acquiring a first image including the first area; and
determining whether or not a first authentication subject, who is a person included in the acquired first image and located in the first area, is permitted to pass through the face authentication gate apparatus, based on a result of face authentication performed on the first authentication subject by using the acquired first image.

15-16. (canceled)
